(19) United States
(12) Patent Application Publication
(10) Pub. No.: US 2006/0082999 A1
(43) Pub. Date: Apr. 20, 2006

(54) Refractive clamp/optic for light emitting diode

(76) Inventor: W. Richard Klein, Houston, TX (US)

Correspondence Address: FULBRIGHT & JAWORSKI, LLP, 1301 MCKINNEY, SUITE 5100, HOUSTON, TX, 77010-3095, US

(21) Appl. No.: 10/967,586

(22) Filed: Oct. 18, 2004

(51) Int. Cl. F21V 3/00; F21V 5/00

(52) U.S. Cl. 362/311

(57) ABSTRACT

The present invention is directed to a signaling device that incorporates a plurality of light emitting diodes and refractive clamp/optics which partially deviates and focuses the radiated light, an outer optic, which centers the beam on the horizon and determines the final vertical divergence, and a means of powering and controlling the device. The means for powering the device is any suitable power source.

### BACKGROUND OF THE INVENTION

The present invention relates to an optic which partially refracts and focuses radiated light rays from light emitting diodes (LEDs). More particularly, the invention relates to clamp/optic rings that refract light from a single LED or an array of LEDs.

Generally, the use of LEDs in signaling devices is known. Typically, these signaling device utilize a single fresnel lens surrounding one ore more LEDs to aid in focusing light from the LEDs.

Another known signaling device, disclosed in U.S. Pat. No. 6,667,582, uses a reflective mirrored system to reflect incident light from an LED. The LED is partially surrounded by a housing with a reflective coating. Light emitted from the LED strikes the reflective coating and is then redirected in a forward manner. The mirror surface acts very much like the mirror in a flash light. Typically, a flash light has a light source, and a generally shaped parabolic mirror which reflects light emitted from the side of the light source in a forward direction.

The use a mirrored surface to reflect light from an LED, however, experiences the problem of loss of some of the light emitted obliquely from the side of the LED near the front. The most intense light rays emitted from an LED are those emitted from the spherical front and the cylindrical side near front of the LED. In other words, using a parabolic surface mirror, these rays represent stray light which is lost to the forward-directed main beam.

Additionally, a reflective mirror surface typically experiences some loss of reflected light as the mirror surface deteriorates with age.

A need therefore exists to improve the forward-directed transmission of a significant amount of light emitted from the frontal sides of an LED. The present invention addresses such a need through the use of a clamp/optic ring whereby light emitted from the side of an LED is redirected by refraction into the forward direction offering the benefit of increased forward light intensity, compared to a reflective light system.

### BRIEF SUMMARY OF THE INVENTION

In one aspect of the invention there is a clamp/optic for precise location of LEDS in an array and for refracting light from the individual LEDs within the array. The clamp/optic comprises two generally similar parts designated as upper clamp/optic and lower clamp/optic. Each of the two parts include a body with a plurality of LED receptacles. The body has a top side and a bottom side and an inner and outer periphery. The LED receptacles have a first recessed channel on the bottom side and also have an optical zone. The first recessed channel has an inner peripheral wall and an outer peripheral wall. The optical zone, formed between the first recessed channel and the outer peripheral wall, is made of an optical grade material and has an inner refractive surface and an outer refractive surface. The outer peripheral wall of the first recessed channel forms the inner refractive surface of the optical zone.

The body of the clamp/optic may be formed in a substantially circular or substantially linear or planar shape, or other useful shape. Preferably, the receptacles are evenly spaced on or about the body. The inner refractive surfaces of the body are optically polished to provide precise refraction and direction of the LED light rays. The optical zone is shaped with the inner refractive surface forming a cylindrical, refracting, air wedge or air prism with the outer, side surface of the LED. Light emitted from the front portion of the cylindrical side of the LED is transmitted through the air wedge into the optical zone through the first surface and hence through the optical zone to the outer refractive surface. The clamp/optic has a second channel adjacent to the inner periphery of the body. The rear flange of the LED base is placed within the second channel of the body to precisely locate the LED with respect to the inner and outer optical surfaces when the clamp/optic and LED array are assembled. The LED is further entrapped by the inner tip of the first optical surface which fits intimately around the LED cylindrical side surface, intercepting all significant light rays emitted through the side of the LED.

The optical zone is made of an optically clear refractive material, such as optical grade polycarbonate or an optical grade acrylic. The entire body may be made of the optically clear material, or be made of some other material in combination with the optically clear material of the optical zone.

The clamp/optic may have a plurality of projections extending from the top side of the body. The projections provide separation of the clamps when stacked top-side to top-side upon one another with a generally planar object, such as a printed circuit board between. These projections may be of any shape or size.

When assembled, an array of LEDs is located within an upper clamp/optic and a lower clamp/optic to provide an efficient refraction of light emitted from the LEDs with minimal stray light losses. The array of LEDs is seated into a first clamp/optic body into the LED receptacles. In particular, the base flange of the LEDs is seated into the second channel of the LED receptacles. A second clamp/optic body is placed over the array of LEDs, likewise, with the base flange of the LEDs seated into the second channel of the LED receptacles. With the array of LEDs seated in the first and second clamps, a substantial area surrounding the LEDs is covered by the LED receptacles.

In another aspect of the invention there is a clamp/optic for refracting light from an LED. The clamp/optic for refracting light from an LED has a body with an LED receptacle. The body has a top side and a bottom side. The clamp/optic body also has an inner periphery and an outer periphery. The LED receptacle has an optical zone formed of an optical material. The LED receptacle also has a first recessed channel. The recessed channel has an inner peripheral wall and an outer peripheral wall. The optical zone has an inner refractive surface and an outer refractive surface. The outer peripheral of the first recessed channel forms the inner refractive surface. The inner refractive surface and outer refractive surface are shaped to refract light from an LED light source. The optic is made of an optically clear material, preferably of an optical grade polycarbonate or an optical grade acrylic. For precise refraction and transmission of light, the inner and outer refractive surfaces are optically polished.

In another aspect of the invention there is a signaling device utilizing a clamp/optic for refracting light from an array of LEDs. The signaling device has electronic circuitry operably connected to a power source. The array of LEDs is operably connected to the electronic circuitry. Such circuitry is commonly known in the art, and may be readily adapted to the present invention. The circuitry may for example, control the operation of the LEDs, such as flashing, or control current/power to the LEDs. A first and second clamp/optic are disposed about the array of LEDS. Each clamp/optic has a body, preferably substantially circular in shape, with a plurality of LED receptacles. The body of the clamp/optic has a top and a bottom side, and the body has an inner and outer periphery. The LED receptacles have an optical zone formed of an optical material, and the receptacles have a first recessed channel. The recessed channel has an inner peripheral wall and an outer peripheral wall. The optical zone has an inner refractive surface and an outer refractive surface, where the outer peripheral wall forms the inner refractive surface. Each of the LEDs in the array has an optical axis which is located within a common plane. The LEDs are spaced at mutually equal interval angles thereby producing an omni-directional beam pattern along the common plane. Polishing the refractive inner and outer optical surfaces aids in precise light directivity and transmittance. The inner refractive surface and outer refractive surface are shaped to refract light from an LED light source. The optic is made of an optically clear material, preferably of an optical grade polycarbonate or an optical grade acrylic.

The clamp/optic body may have a plurality of projections extending from the top side of the body. The projections provide separation of the clamps when stacked top-side to top-side upon one another with a planar object, such as a printed circuit board, in between. These projections may be of any shape.

The means for powering the signaling device is either a photovoltaic system or a battery supply, or other commonly known power supply.

In one embodiment, the signaling device may have a hollow base, a passive top connected to a photovoltaic panel mounted on the top and an outer optic enclosing the clamp/optic rings and plurality of LEDs, all disposed on the hollow base. The plurality of LEDs is connected electrically to an electronic circuit board. The photovoltaic top is connected electrically to the electronic circuit board and at least one electrolytic cell disposed inside the hollow base. The photovoltaic, top, having a transparent cover to allow sunlight in, charges the electrolytic cell to power the signaling device and the electronic circuit board, thus controlling the flashing of the signaling device. The signaling device may alternatively use an external battery for back up power or primary power. Moreover, various embodiments of signaling devices may be utilized with the inventive clamp/optics. For example, other embodiments may utilize a self-contained chargeable or non-rechargeable battery source. Other embodiments may utilize an external power source. Additionally, various housing and outer optical housings may be utilized in combination with the clamp/optic rings.

The signaling devices described herein may be utilized in a number of applications, such as marine signaling device, aircraft signaling devices, traffic signaling devices, beacons, vehicle signaling devices. The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following description taken in conjunction with the accompanying drawing, in which:

FIG. 1 is an illustrative view showing optical properties of a common LED;

FIG. 2 is an illustrative view showing optics of an LED light rays reflected from a curved mirror surface;

FIG. 3 is an illustrative view showing optics of the invention where light rays are refracted via a lens;

FIG. 4 is an illustrative view showing the inventive LED clamp/optic;

FIG. 5A is a top view showing the top side of the LED clamp/optic;

FIG. 5B is a bottom view showing the bottom side of the LED clamp/optic;

FIG. 5C is a perspective top view showing the top side of the LED clamp/optic;

FIG. 5D is a perspective bottom view showing the bottom side of the LED clamp/optic;

FIG. 6 is a section view of the combination of an embodiment of the LED clamp/optics with an outer lens;

FIG. 7 is a illustrative view of a signaling device utilizing the inventive LED clamp/optic; and

FIG. 8 is an illustrative view of an embodiment of the LED clamp/optic show as flat panel.

### DETAILED DESCRIPTION OF THE INVENTION

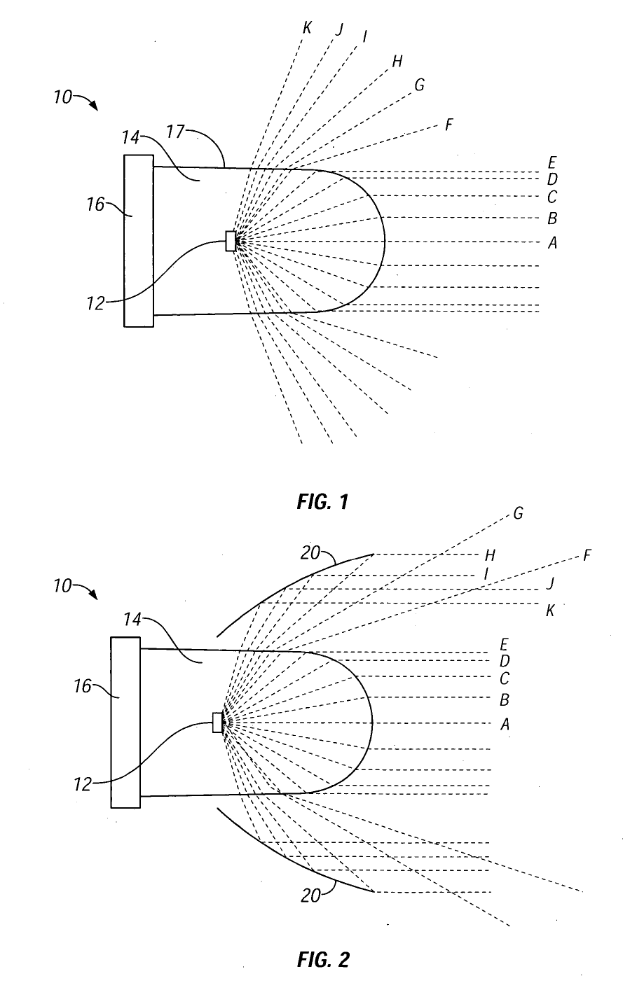

When a light emitting diode (LED) is used as a light source, a prime consideration is the maximization of the ratio of useful light output to electrical energy input. Referring to FIG. 1, the optics of a type of LED 10 commonly used for illumination and for lighted signal devices is shown. The LED die 12 is a small, solid state, light source embedded in a transparent plastic envelope 14 and typically has a base flange 16. Light rays A-K, thin beams of light traveling in a straight line, emerge from the die 12 and are refracted at the outer LED surface 17, assuming new directions according to Snell's Law. Those rays A-E which pass through the quasi-spherical front surface of the LED envelope are projected in a (near) forward direction where they contribute to useful illumination. A major fraction of the emitted light passes through the sides of the LED (rays F-K) where it is lost to the main forward directed beam.

Two methods of elementary optics for redirecting light are reflection and refraction. FIG. 2 shows a diagram of a light gathering mirror 20 surrounding an LED 10. Light rays H-K are redirected into the forward direction by reflection, contributing to the intensity of the main beam. However, for a finite mirror, rays F and G, which are typically of greater intensity than rays H-K are lost with respect to the forward-directed beam, due to the necessity of the mirror opening from rear to front.

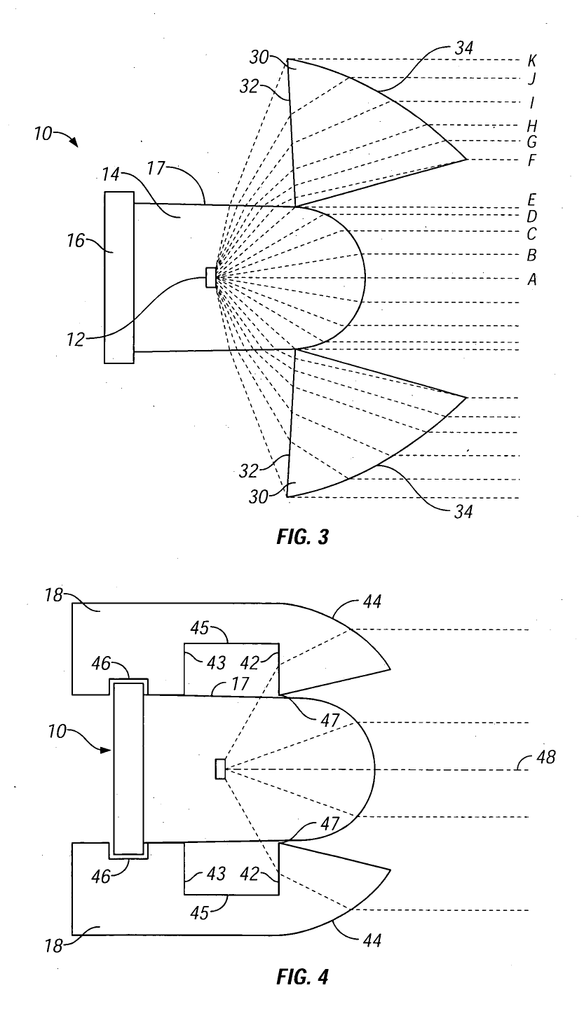

FIG. 3 refers to an illustrative view of the optics of the present invention where light rays F-K are refracted through an optical zone 30. The optical surfaces 32 and 34 of each of the optical zones 30 contain a transparent solid. Rays F-K are bent at the optical surfaces according to Snell's Law to be redirected into the main forward beam. The arrangement shown in FIG. 3 has the advantage of collecting the more intense rays, F and G are redirecting them along the direction of the main beam.

One embodiment of the refracting clamp/optic is shown in FIG. 4. Surfaces 42 and 44 form optical surfaces corresponding to surfaces 32 and 34 in FIG. 3. These surfaces form an optical zone. Optical and secondary surfaces are rotated about the optical axis 48 of the LED 10. An LED 10 is located and directed by inner clamping surfaces at 46 and by contact at 47. The clamping surfaces at 46 may or may not be rotated about the optic axis. The refractive clamp/optic 18 typically consists of two parts, designated as upper clamp/optic and lower clamp/optic, respectively, which are physically separate prior to assembly.

The surfaces 42, 43, and 45 form a first channel. The recessed surface 46 forms a second channel. The first channel is an open area shaped in a manner to allow light passing through the sides of the LED 10 to pass through optical surface 42 and thereby refracting the light to pass through optical surface 44. The first channel may be of any suitable shape to allow light passing through the sides of the LED 10 to pass through optical surface 42. Optical surface 42 forms a portion of the optical zone.

The clamp/optic may be manufactured from a wide variety of materials commonly used by those skilled in the art for manufacturing optics. Examples of suitable materials include optical grade acrylic and polycarbonate. There are a number of manufacturing techniques which may be used to manufacture the upper clamp/optic and lower clamp/optic. The clamp/optic may be manufactured by injection molding to minimize costs. When manufacturing the clamp/optic by injection molding techniques, it is advantageous to design a part or parts, which can be molded in a two piece mold, which is considerably lower in cost that a complex three-piece mold. Manufacturing by injection molding with a two piece mold may be accomplished by design of the clamp/optic such that both optical surfaces have single-directional draft for removal from the mold.

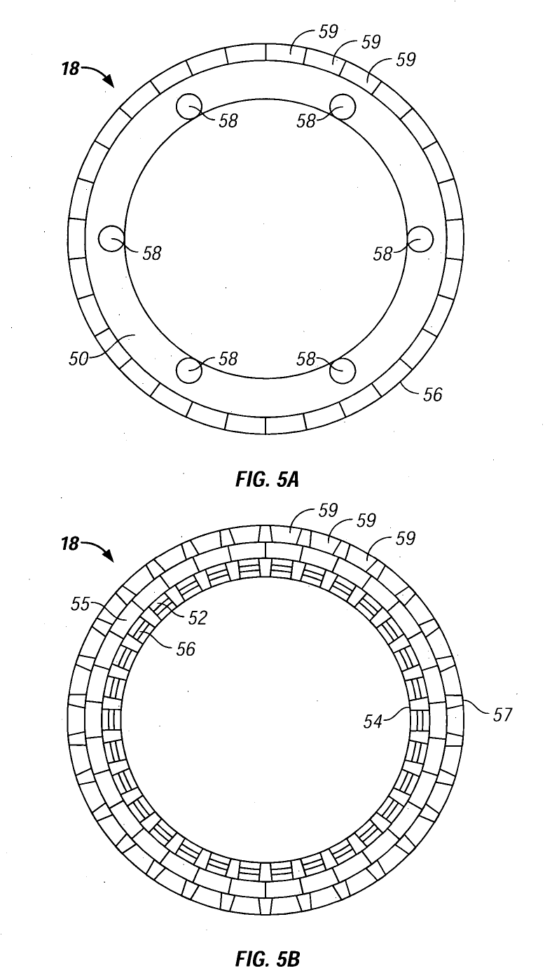

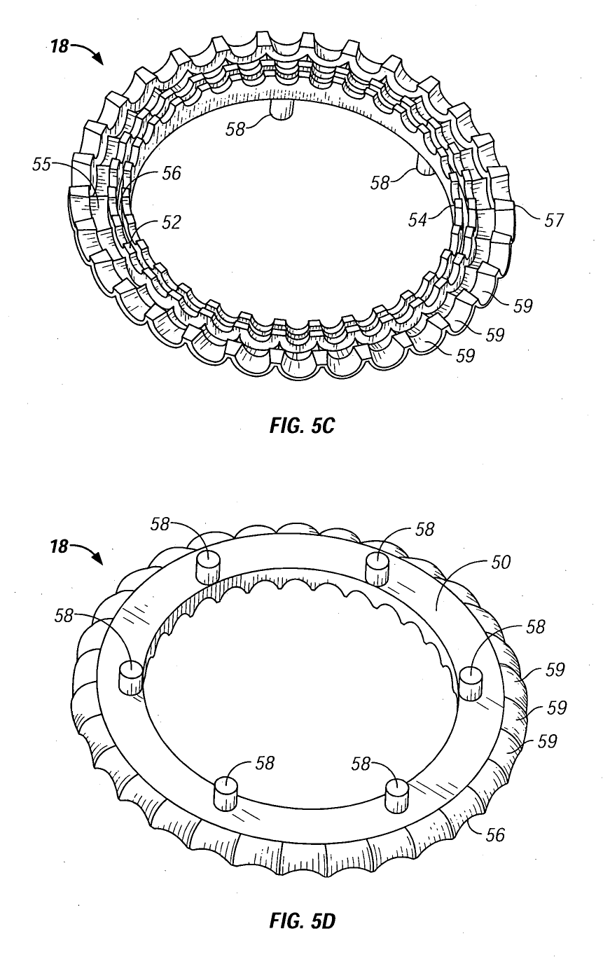

Referring to FIGS. 5A-D top-view and bottom views of one embodiment of the LED clamp/optic is shown. The configuration shown in FIGS. 5A-5B holds 30 LEDs at 12 degree intervals. (FIG. 4 showed a vertical section view through the center of a 12 degree cell.) Two refracting clamp/optics 18 are assembled together with an array of LEDs. The refracting clamps 18 have an inner periphery 54 and an outer periphery 57. Top views of the clamps are shown in FIGS. 5A and 5D. Bottom views are shown in FIGS. 5B and 5C. The top side of the clamp/optic is generally designated with the reference 50. The bottom side of the clamp/optic is generally designated with the reference 52. The clamp/optic 18 may have a plurality of projections 58 extending from the top side 50 of the body of the clamp/optic. The projections 58 provide separation of the clamp/optics when stacked top-side to top-side upon one another with a planar object such as a printed circuit board between. These projections may be of any shape or size. The optical zone is shown as reference number 59. Only three of the optical zones 59 have been labeled. Also, shown on the bottom view of the clamp/optics are channels 55 and 56. These channels correspond to the recessed surfaces 45 and 46 of FIG. 4. The bottom side of the clamp/optic 18 is formed in a manner to provide a receptacle or housing for the LEDs.

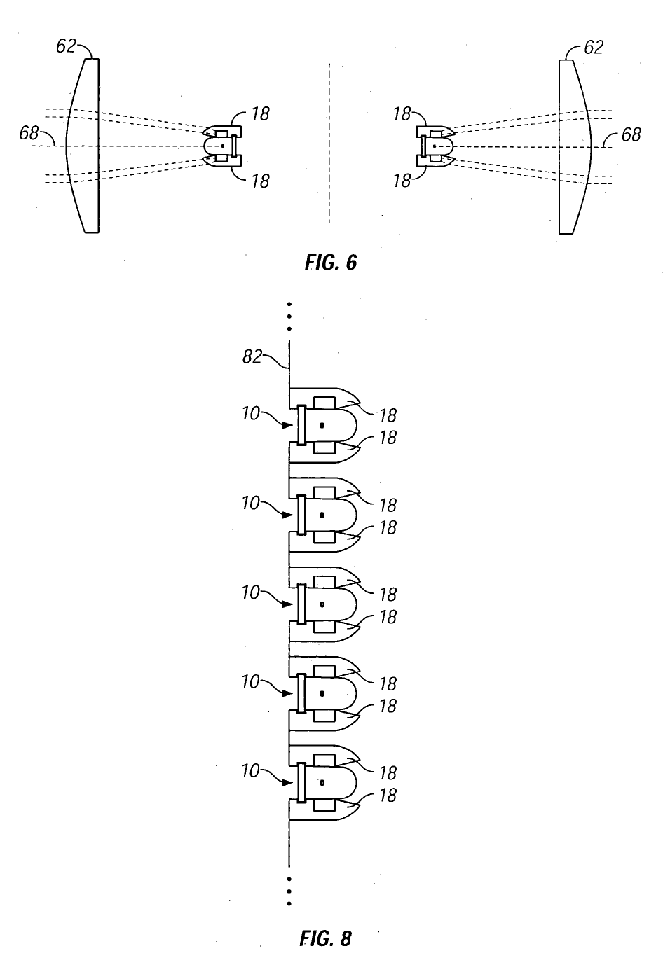

In one embodiment of the invention, there is a signaling device light having a series of LEDs, with optic axes located within a plane 68 and directed at mutually equal interval angles and producing an omni-directional beam pattern along the common optic plane. A partial view of the signaling device is shown in FIG. 6. The refracting optical surfaces of the clamp/optic and outer lens 62 may be custom designed to achieve a vertical divergence of the emergent beam required for the particular application. Multiple units such as that shown in FIG. 6 may be stacked vertically to increase the total light intensity.

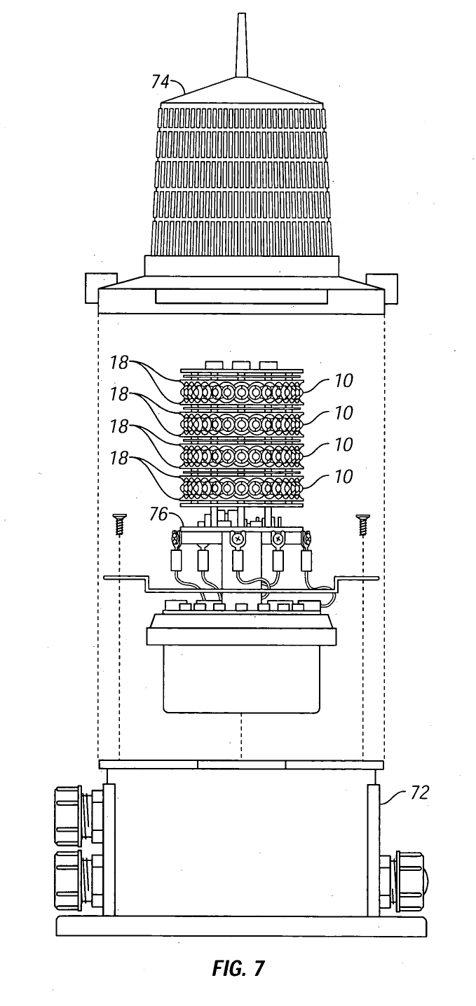

Referring to FIG. 7, a view of one embodiment of the present invention is shown. The signaling device comprises a base 72 and outer optic 74. The outer optic 74 is mountable to the base 72.

The refracting clamp/optic 18 containing a plurality of LEDs is disposed inside the space inside the outer optic 74. As shown a number of combined clamp/optics with corresponding array of LEDS 10 may be stacked one upon another. In the figure, four such combinations are provided with the signaling device. The plurality of LEDs 10 is connected operably to electronic circuitry. The electronic circuitry 76 (not shown in detail) is connected operably to an external or internal electrical power source, and controls flashing of the plurality of LEDs.

The base 72 has a bottom surface and a wall surface extending vertically from the bottom surface. The bottom surface may extend past the wall surface, forming a flange. The wall surface may be cylindrical, causing the base to have a cylinder shape. The wall surface may also be other shapes other than cylindrical, including square or rectangular. The wall surface may vary in thickness. The wall surface forms a hollow center to the base, where the volume of the hollow center is determined by the diameter of the base and the thickness of the wall surface. It should be understood that the size, shape and configuration of the base might be varied to accommodate various applications. Preferably the shape of the base is a hollow ring with a flat bottom surface.

The base 72 may be made of any materials that are suitable for marine or outdoor use. The base may be composed of materials that will float on water, or may be composed of non-floating materials. If the base is connected to a stand, buoy or other structure to hold the signaling device, the base fulfills the purpose of housing the electric circuitry and protects it from the elements in a marine or other harsh environment.

Electrolytic cells, batteries, electronic power supply, or any other suitable power source may be used to provide power for the signaling device. The power source is operably connected to the electronic circuitry and the array of LEDs. One skilled in the art would know how to configure the electronic circuitry and power an array of LEDs. One skilled in the art would also understand the variety of electrical power sources available for use in applications for signaling devices, and would understand the electronic configuration connecting the electrical power source and the electronic circuitry powering the plurality of LEDs for operation of the signaling device.

The electronic circuitry is operably connected to the plurality of LEDs and the electrical power source to power and control the flashing of the plurality of LEDs of the present invention. The electronic circuitry may comprise a printed electronic circuit board. The electronic circuitry may also comprise other configurations that are not pre-printed onto a circuit board. One skilled in the art would understand the electronic configuration of circuits and components of the electronic circuitry required to control flashing of the plurality of LEDs.

The plurality of LEDs may be any suitable color for a particular application, such as red, green, white, blue and yellow models, all of which may be appropriate for use in the present invention. The plurality of LEDs is connected operably to the electronic circuitry adapted to control the signal light from the LEDs. The light emitted from the plurality of LEDs can be controlled to emit light in a steady beam, or any pattern of flashing for use as a signal.

In another embodiment, the refractive clamp/optic described here and shown in FIG. 8 may be used to enhance the intensity of a series of either linear or planar arrays of LEDs. Refracting clamp/optics 18 may be fabricated individually or mutually attached to each other and may be arrayed in a variety of display patterns. As shown in the figure, a plurality of clamp/optics is assembled with an array of LEDs on a mounting panel 82.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. An apparatus for refracting light from an array of LEDs, said apparatus comprising:
a body having a plurality of LED receptacles, said body having a top side and a bottom side, said body having an inner periphery and an outer periphery;
said LED receptacles comprising an optical zone made of an optical material and a first recessed channel, said recessed channel having an inner peripheral wall and an outer peripheral wall, said optical zone comprising an inner refractive surface and an outer refractive surface, said outer peripheral wall forming said inner refractive surface.

2. The apparatus of claim 1, wherein the body is formed substantially circular in shape.

3. The apparatus of claim 1, wherein the body is formed substantially planar in shape.

4. The apparatus of claim 1, wherein said receptacles are evenly spaced about said body.

5. The apparatus of claim 1, wherein the refractive inner surface and the refractive outer surface are optically polished.

6. The apparatus of claim 1, wherein said inner refractive surface and outer refractive surface are shaped to refract light from an LED light source.

7. The apparatus of claim 1, further comprising a second channel adjacent the inner periphery of the body.

8. The apparatus of claim 1, wherein the optical material is comprised of an optical grade polycarbonate or an optical grade acrylic.

9. The apparatus of claim 1, further comprising a plurality of projections extending vertically from the top side of the body.

10. An apparatus for refracting light from an LED, said apparatus comprising:
a body having an LED receptacle, said body having a top side and a bottom side, said body having an inner periphery and an outer periphery; and
said LED receptacle comprising an optical zone formed of an optical material and a first recessed channel, said recessed channel having an inner peripheral wall and an outer peripheral wall, said optical zone comprising an inner refractive surface and an outer refractive surface, said outer peripheral wall forming said inner refractive surface;
wherein said inner refractive surface and outer refractive surface are shaped to refract light from an LED light source.

11. The apparatus of claim 10, wherein the optical material is comprised of an optical grade polycarbonate.

12. The apparatus of claim 10, wherein the optical material is comprised of an optical grade acrylic.

13. The apparatus of claim 10, wherein the refractive inner surface and refractive outer surface are optically polished.

14. A signaling device comprising:
a power source;
electronic circuitry connected to said power source an array of LEDs operably connected to said electronic circuitry; and
a first and second clamp disposed about said array of LEDS, each clamp comprising a body having a plurality of LED receptacles, said body having a top side and a bottom side, said body having an inner periphery and an outer periphery, said LED receptacles comprising an optical zone formed of an optical material and a first recessed channel, said recessed channel having an inner peripheral wall and an outer peripheral wall, said optical zone comprising an inner refractive surface and an outer refractive surface, said outer peripheral wall forming said inner refractive surface.

15. The signaling device of claim 14, wherein the body is formed substantially circular in shape.

16. The signaling device of clamp 14, wherein the array of LEDS have an optical axes located within a common plane and the LEDS are spaced at mutually equal interval angles thereby producing an omni-directional beam pattern along the common plane.

17. The signaling device of claim 14, wherein the body is formed substantially planar in shape.

18. The signaling device of claim 14, wherein said receptacles are evenly spaced about said body.

19. The signaling device of claim 14, wherein the refractive outer surface and inner surface are optically polished.

20. The signaling device of claim 14, wherein said inner refractive surface and outer refractive surface are shaped to refract light from an LED light source.

21. The signaling device of claim 14, further comprising a second channel adjacent the inner periphery of the body.

22. The signaling device of claim 14, wherein the optical material is comprised of an optical grade polycarbonate, or an optical grade acrylic.

23. The signaling device of claim 14, further comprising a plurality of projections extending vertically from the top side of the body.
